(19) United States
(12) Patent Application Publication
(10) Pub. No.: US 2026/0330433 A1
(43) Pub. Date: Oct. 22, 2026

(54) APPARATUS AND METHOD FOR FIRST INFLUENCE ACTIVATION USING MACHINE LEARNING

(71) Applicant: Vybe Fintech LLC, Sacramento, CA (US)

(72) Inventor: Kyle Noel Jackson, Elk Grove, CA (US)

(21) Appl. No.: 19/649,621

(22) Filed: Apr. 16, 2026

Related U.S. Application Data
(60) Provisional application No. 63/789,589, filed on Apr. 16, 2025.

(51) Int. Cl. G06Q 10/46

(52) U.S. Cl. CPC G06Q 10/46

(57) ABSTRACT

Provided for herein are an apparatus and method for first influence activation using machine learning. The method comprises receiving, by at least a processor, a first influence account linked to a user; confirming, the authenticity of the first influence account linked to the user; verifying the identity of the user; calculating, a first value for the first influence account; receiving, a request for collateral from the user; and approving, the request for collateral using the first value, wherein the first influence account is to be used as an asset for collateral.

### CROSS-REFERENCE TO RELATED APPLICATIONS

This application claims the benefit of priority of U.S. Provisional Application No. 63/789,589 filed on Apr. 16, 2025, and entitled “METHODS AND SYSTEMS FOR CALCULATING FINANCIAL TRANSFERS SECURED BY DIGITAL ASSETS” the entirety of which is incorporated by reference.

### FIELD OF THE INVENTION

The present invention generally relates to the field of computing. In particular, the present invention is directed to an apparatus and method for first influence activation using machine learning.

### BACKGROUND

Transactions involving digital assets can be challenging to execute due to limitations in accurate valuation and reliable account authentication, which may restrict a user's ability to access services or modalities they would otherwise be eligible for.

### SUMMARY

In an aspect, an apparatus for first influence activation using machine learning, the apparatus comprising at least a processor; and a memory communicatively connected to the at least a processor the memory containing instructions configuring the at least a processor to receive a first influence account linked to a user; confirm the authenticity of the first influence account linked to the user; verify the identity of the user; calculate a first value for the first influence account, wherein calculating the first value further comprises generating a training data set, wherein the training data set comprises a plurality of inputs containing influence accounts correlated to outputs containing valuations; training, a machine learning model using the generated training data set; inputting the first influence account into the trained machine learning model; outputting a valuation for the first influence account; and identifying a first value using the valuation; receive a request for collateral from the user; and approve the request for collateral using the first value, wherein the first influence account is to be used as an asset for collateral.

In yet another non-limiting example, A method of first influence activation using machine learning, the method comprising: receiving, by at least a processor, a first influence account linked to a user confirming, by the at least a processor, the authenticity of the first influence account linked to the user; verifying, by the at least a processor, the identity of the user; calculating by the at least a processor, a first value for the first influence account, wherein calculating the first value further comprises generating a training data set, wherein the training data set comprises a plurality of inputs containing influence accounts correlated to outputs containing valuations; training, a machine learning model using the generated training data set; inputting the first influence account into the trained machine learning model; outputting a valuation for the first influence account; and identifying a first value using the valuation; receiving, by the at least a processor, a request for collateral from the user; approving, by the at least a processor, the request for collateral using the first value, wherein the first influence account is to be used for as an asset for collateral.

### BRIEF DESCRIPTION OF THE DRAWINGS

Aspects and advantages of the present disclosure will become apparent from the following exemplary embodiments taken in conjunction with the accompanying drawings. However, it should be understood that the present invention is not limited to the precise arrangements and instrumentalities shown in the drawings, wherein:

FIG. 1 is a flow diagram illustrating an exemplary embodiment of a blockchain;

FIG. 2 is a block diagram of an exemplary embodiment of a machine-learning process;

FIG. 3 is a diagram of an exemplary embodiment of a neural network;

FIG. 4 is a diagram of an exemplary embodiment of a node of a neural network;

FIG. 5 is a block diagram of a computing system that can be used to implement any one or more of the methodologies disclosed herein and any one or more portions thereof;

FIG. 6 is a block diagram of an exemplary embodiment of an apparatus for first influence activation using machine learning; and

FIG. 7 is a process flow diagram illustrating an exemplary embodiment of a method of first influence activation using machine learning.

### DETAILED DESCRIPTION

At a high level, aspects of the present invention are directed to an apparatus and method for first influence activation using machine learning.

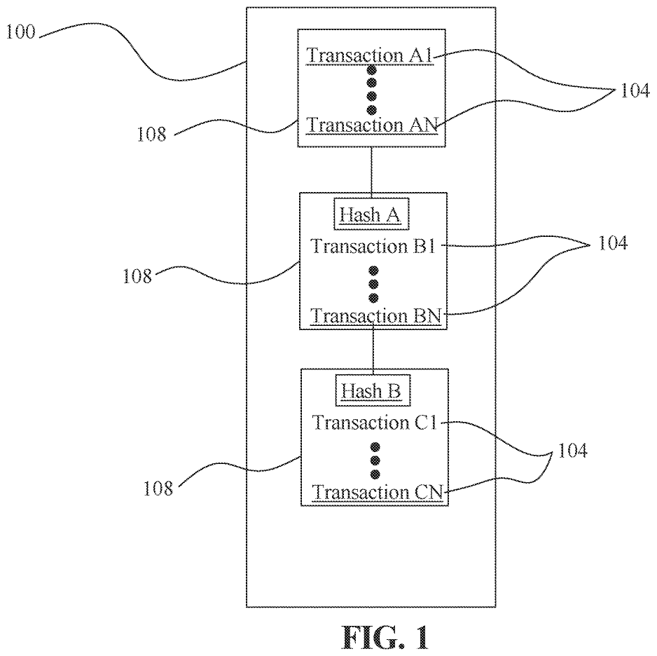

Referring now to FIG. 1, an exemplary embodiment of an immutable sequential listing 100 is illustrated. Data elements are listing in immutable sequential listing 100; data elements may include any form of data, including textual data, image data, encrypted data, cryptographically hashed data, and the like. Data elements may include, without limitation, one or more at least a digitally signed assertion. In one embodiment, a digitally signed assertion 104 is a collection of textual data signed using a secure proof as described in further detail below; secure proof may include, without limitation, a digital signature as described above. Collection of textual data may contain any textual data, including without limitation American Standard Code for Information Interchange (ASCII), Unicode, or similar computer-encoded textual data, any alphanumeric data, punctuation, diacritical mark, or any character or other marking used in any writing system to convey information, in any form, including any plaintext or cyphertext data; in an embodiment, collection of textual data may be encrypted, or may be a hash of other data, such as a root or node of a Merkle tree or hash tree, or a hash of any other information desired to be recorded in some fashion using a digitally signed assertion 104. In an embodiment, collection of textual data states that the owner of a certain transferable item represented in a digitally signed assertion 104 register is transferring that item to the owner of an address. A digitally signed assertion 104 may be signed by a digital signature created using the private key associated with the owner's public key, as described above.

Still referring to FIG. 1, a digitally signed assertion 104 may describe a transfer of virtual currency, such as crypto-currency as described below. The virtual currency may be a digital currency. Item of value may be a transfer of trust, for instance represented by a statement vouching for the identity or trustworthiness of the first entity. Item of value may be an interest in a fungible negotiable financial instrument representing ownership in a public or private corporation, a creditor relationship with a governmental body or a corporation, rights to ownership represented by an option, derivative financial instrument, commodity, debt-backed security such as a bond or debenture or other security as described in further detail below. A resource may be a physical machine e.g. a ride share vehicle or any other asset. A digitally signed assertion 104 may describe the transfer of a physical good; for instance, a digitally signed assertion 104 may describe the sale of a product. In some embodiments, a transfer nominally of one item may be used to represent a transfer of another item; for instance, a transfer of virtual currency may be interpreted as representing a transfer of an access right; conversely, where the item nominally transferred is something other than virtual currency, the transfer itself may still be treated as a transfer of virtual currency, having value that depends on many potential factors including the value of the item nominally transferred and the monetary value attendant to having the output of the transfer moved into a particular user's control. The item of value may be associated with a digitally signed assertion 104 by means of an exterior protocol, such as the COLORED COINS created according to protocols developed by The Colored Coins Foundation, the MASTERCOIN protocol developed by the Mastercoin Foundation, or the ETHEREUM platform offered by the Stiftung Ethereum Foundation of Baar, Switzerland, the Thunder protocol developed by Thunder Consensus, or any other protocol.

Still referring to FIG. 1, in one embodiment, an address is a textual datum identifying the recipient of virtual currency or another item of value in a digitally signed assertion 104. In some embodiments, address is linked to a public key, the corresponding private key of which is owned by the recipient of a digitally signed assertion 104. For instance, address may be the public key. Address may be a representation, such as a hash, of the public key. Address may be linked to the public key in memory of a computing device, for instance via a “wallet shortener” protocol. Where address is linked to a public key, a transferee in a digitally signed assertion 104 may record a subsequent a digitally signed assertion 104 transferring some or all of the value transferred in the first a digitally signed assertion 104 to a new address in the same manner. A digitally signed assertion 104 may contain textual information that is not a transfer of some item of value in addition to, or as an alternative to, such a transfer. For instance, as described in further detail below, a digitally signed assertion 104 may indicate a confidence level associated with a distributed storage node as described in further detail below.

In an embodiment and still referring to FIG. 1 immutable sequential listing 100 records a series of at least a posted content in a way that preserves the order in which the at least a posted content took place. Temporally sequential listing may be accessible at any of various security settings; for instance, and without limitation, temporally sequential listing may be readable and modifiable publicly, may be publicly readable but writable only by entities and/or devices having access privileges established by password protection, confidence level, or any device authentication procedure or facilities described herein, or may be readable and/or writable only by entities and/or devices having such access privileges. Access privileges may exist in more than one level, including, without limitation, a first access level or community of permitted entities and/or devices having ability to read, and a second access level or community of permitted entities and/or devices having ability to write; first and second community may be overlapping or non-overlapping. In an embodiment, posted content and/or immutable sequential listing 100 may be stored as one or more zero knowledge sets (ZKS), Private Information Retrieval (PIR) structure, or any other structure that allows checking of membership in a set by querying with specific properties. Such database may incorporate protective measures to ensure that malicious actors may not query the database repeatedly in an effort to narrow the members of a set to reveal uniquely identifying information of a given posted content.

Still referring to FIG. 1, immutable sequential listing 100 may preserve the order in which the at least a posted content took place by listing them in chronological order; alternatively or additionally, immutable sequential listing 100 may organize digitally signed assertions 104 into sub-listings 108 such as “blocks” in a blockchain, which may be themselves collected in a temporally sequential order; digitally signed assertions 104 within a sub-listing 108 may or may not be temporally sequential. The ledger may preserve the order in which at least a posted content took place by listing them in sub-listings 108 and placing the sub-listings 108 in chronological order. The immutable sequential listing 100 may be a distributed, consensus-based ledger, such as those operated according to the protocols promulgated by Ripple Labs, Inc., of San Francisco, Calif., or the Stellar Development Foundation, of San Francisco, Calif, or of Thunder Consensus. In some embodiments, the ledger is a secured ledger; in one embodiment, a secured ledger is a ledger having safeguards against alteration by unauthorized parties. The ledger may be maintained by a proprietor, such as a system administrator on a server, that controls access to the ledger; for instance, the user account controls may allow contributors to the ledger to add at least a posted content to the ledger, but may not allow any users to alter at least a posted content that have been added to the ledger. In some embodiments, ledger is cryptographically secured; in one embodiment, a ledger is cryptographically secured where each link in the chain contains encrypted or hashed information that makes it practically infeasible to alter the ledger without betraying that alteration has taken place, for instance by requiring that an administrator or other party sign new additions to the chain with a digital signature. Immutable sequential listing 100 may be incorporated in, stored in, or incorporate, any suitable data structure, including without limitation any database, datastore, file structure, distributed hash table, directed acyclic graph or the like. In some embodiments, the timestamp of an entry is cryptographically secured and validated via trusted time, either directly on the chain or indirectly by utilizing a separate chain. In one embodiment the validity of timestamp is provided using a time stamping authority as described in the RFC 3161 standard for trusted timestamps, or in the ANSI ASC x9.95 standard. In another embodiment, the trusted time ordering is provided by a group of entities collectively acting as the time stamping authority with a requirement that a threshold number of the group of authorities sign the timestamp.

In some embodiments, and with continued reference to FIG. 1, immutable sequential listing 100, once formed, may be inalterable by any party, no matter what access rights that party possesses. For instance, immutable sequential listing 100 may include a hash chain, in which data is added during a successive hashing process to ensure non-repudiation. Immutable sequential listing 100 may include a block chain. In one embodiment, a block chain is immutable sequential listing 100 that records one or more new at least a posted content in a data item known as a sub-listing 108 or “block.” An example of a block chain is the BITCOIN block chain used to record BITCOIN transactions and values. Sub-listings 108 may be created in a way that places the sub-listings 108 in chronological order and link each sub-listing 108 to a previous sub-listing 108 in the chronological order so that any computing device may traverse the sub-listings 108 in reverse chronological order to verify any at least a posted content listed in the block chain. Each new sub-listing 108 may be required to contain a cryptographic hash describing the previous sub-listing 108. In some embodiments, the block chain contains a single first sub-listing 108 sometimes known as a “genesis block.”

Still referring to FIG. 1, the creation of a new sub-listing 108 may be computationally expensive; for instance, the creation of a new sub-listing 108 may be designed by a “proof of work” protocol accepted by all participants in forming the immutable sequential listing 100 to take a powerful set of computing devices a certain period of time to produce. Where one sub-listing 108 takes less time for a given set of computing devices to produce the sub-listing 108 protocol may adjust the algorithm to produce the next sub-listing 108 so that it will require more steps; where one sub-listing 108 takes more time for a given set of computing devices to produce the sub-listing 108 protocol may adjust the algorithm to produce the next sub-listing 108 so that it will require fewer steps. As an example, protocol may require a new sub-listing 108 to contain a cryptographic hash describing its contents; the cryptographic hash may be required to satisfy a mathematical condition, achieved by having the sub-listing 108 contain a number, called a nonce, whose value is determined after the fact by the discovery of the hash that satisfies the mathematical condition. Continuing the example, the protocol may be able to adjust the mathematical condition so that the discovery of the hash describing a sub-listing 108 and satisfying the mathematical condition requires more or less steps, depending on the outcome of the previous hashing attempt. Mathematical condition, as an example, might be that the hash contains a certain number of leading zeros and a hashing algorithm that requires more steps to find a hash containing a greater number of leading zeros, and fewer steps to find a hash containing a lesser number of leading zeros. In some embodiments, production of a new sub-listing 108 according to the protocol is known as “mining.” The creation of a new sub-listing 108 may be designed by a “proof of stake” protocol as will be apparent to those skilled in the art upon reviewing the entirety of this disclosure.

Continuing to refer to FIG. 1, in some embodiments, protocol also creates an incentive to mine new sub-listings 108. The incentive may be financial; for instance, successfully mining a new sub-listing 108 may result in the person or entity that mines the sub-listing 108 receiving a predetermined amount of currency. The currency may be fiat currency. Currency may be cryptocurrency as defined below. In other embodiments, incentive may be redeemed for particular products or services; the incentive may be a gift certificate with a particular business, for instance. In some embodiments, incentive is sufficiently attractive to cause participants to compete for the incentive by trying to race each other to the creation of sub-listings 108 Each sub-listing 108 created in immutable sequential listing 100 may contain a record or at least a posted content describing one or more addresses that receive an incentive, such as virtual currency, as the result of successfully mining the sub-listing 108.

With continued reference to FIG. 1, where two entities simultaneously create new sub-listings 108, immutable sequential listing 100 may develop a fork; protocol may determine which of the two alternate branches in the fork is the valid new portion of the immutable sequential listing 100 by evaluating, after a certain amount of time has passed, which branch is longer. “Length” may be measured according to the number of sub-listings 108 in the branch. Length may be measured according to the total computational cost of producing the branch. Protocol may treat only at least a posted content contained the valid branch as valid at least a posted content. When a branch is found invalid according to this protocol, at least a posted content registered in that branch may be recreated in a new sub-listing 108 in the valid branch; the protocol may reject “double spending” at least a posted content that transfer the same virtual currency that another at least a posted content in the valid branch has already transferred. As a result, in some embodiments the creation of fraudulent at least a posted content requires the creation of a longer immutable sequential listing 100 branch by the entity attempting the fraudulent at least a posted content than the branch being produced by the rest of the participants; as long as the entity creating the fraudulent at least a posted content is likely the only one with the incentive to create the branch containing the fraudulent at least a posted content, the computational cost of the creation of that branch may be practically infeasible, guaranteeing the validity of all at least a posted content in the immutable sequential listing 100.

Still referring to FIG. 1, additional data linked to at least a posted content may be incorporated in sub-listings 108 in the immutable sequential listing 100; for instance, data may be incorporated in one or more fields recognized by block chain protocols that permit a person or computer forming a at least a posted content to insert additional data in the immutable sequential listing 100. In some embodiments, additional data is incorporated in an unspendable at least a posted content field. For instance, the data may be incorporated in an OP_RETURN within the BITCOIN block chain. In other embodiments, additional data is incorporated in one signature of a multi-signature at least a posted content. In an embodiment, a multi-signature at least a posted content is at least a posted content to two or more addresses. In some embodiments, the two or more addresses are hashed together to form a single address, which is signed in the digital signature of the at least a posted content. In other embodiments, the two or more addresses are concatenated. In some embodiments, two or more addresses may be combined by a more complicated process, such as the creation of a Merkle tree or the like. In some embodiments, one or more addresses incorporated in the multi-signature at least a posted content are typical crypto-currency addresses, such as addresses linked to public keys as described above, while one or more additional addresses in the multi-signature at least a posted content contain additional data related to the at least a posted content; for instance, the additional data may indicate the purpose of the at least a posted content, aside from an exchange of virtual currency, such as the item for which the virtual currency was exchanged. In some embodiments, additional information may include network statistics for a given node of network, such as a distributed storage node, e.g. the latencies to nearest neighbors in a network graph, the identities or identifying information of neighboring nodes in the network graph, the trust level and/or mechanisms of trust (e.g. certificates of physical encryption keys, certificates of software encryption keys, (in non-limiting example certificates of software encryption may indicate the firmware version, manufacturer, hardware version and the like), certificates from a trusted third party, certificates from a decentralized anonymous authentication procedure, and other information quantifying the trusted status of the distributed storage node) of neighboring nodes in the network graph, IP addresses, GPS coordinates, and other information informing location of the node and/or neighboring nodes, geographically and/or within the network graph. In some embodiments, additional information may include history and/or statistics of neighboring nodes with which the node has interacted. In some embodiments, this additional information may be encoded directly, via a hash, hash tree or other encoding.

With continued reference to FIG. 1, in some embodiments, virtual currency is traded as a crypto-currency. In one embodiment, a crypto-currency is a digital, currency such as Bitcoins, Peercoins, Namecoins, and Litecoins. Crypto-currency may be a clone of another crypto-currency. The crypto-currency may be an “alt-coin.” Crypto-currency may be decentralized, with no particular entity controlling it; the integrity of the crypto-currency may be maintained by adherence by its participants to established protocols for exchange and for production of new currency, which may be enforced by software implementing the crypto-currency. Crypto-currency may be centralized, with its protocols enforced or hosted by a particular entity. For instance, crypto-currency may be maintained in a centralized ledger, as in the case of the XRP currency of Ripple Labs, Inc., of San Francisco, Calif. In lieu of a centrally controlling authority, such as a national bank, to manage currency values, the number of units of a particular crypto-currency may be limited; the rate at which units of crypto-currency enter the market may be managed by a mutually agreed-upon process, such as creating new units of currency when mathematical puzzles are solved, the degree of difficulty of the puzzles being adjustable to control the rate at which new units enter the market. Mathematical puzzles may be the same as the algorithms used to make productions of sub-listings 108 in a block chain computationally challenging; the incentive for producing sub-listings 108 may include the grant of new crypto-currency to the miners. Quantities of crypto-currency may be exchanged using at least a posted content as described above.

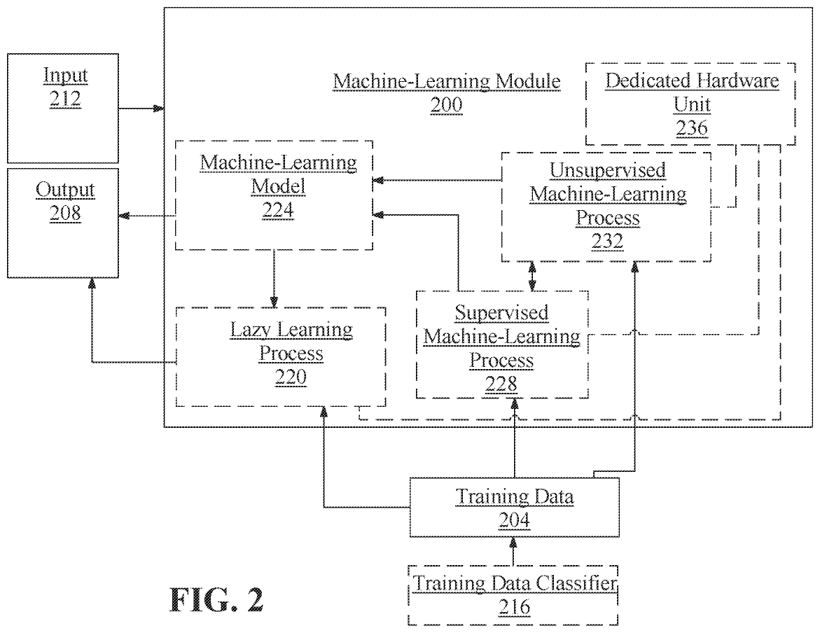

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm that will be performed by a computing device/module to produce outputs 208 given data provided as inputs 212; this is in contrast to a non-machine learning software program where the commands to be executed are determined in advance by a user and written in a programming language.

Still referring to FIG. 2, “training data,” as used herein, is data containing correlations that a machine-learning process may use to model relationships between two or more categories of data elements. For instance, and without limitation, training data 204 may include a plurality of data entries, each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure.

Further referring to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 200 may generate a classifier using a classification algorithm, defined as a process whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 2, machine-learning processes as described in this disclosure may be used to generate machine-learning models 224. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include inputs such as one or more data inputs relating to as described above as inputs, credit scores, credit risks, and approved money transfers as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

Further referring to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including, without limitation, support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

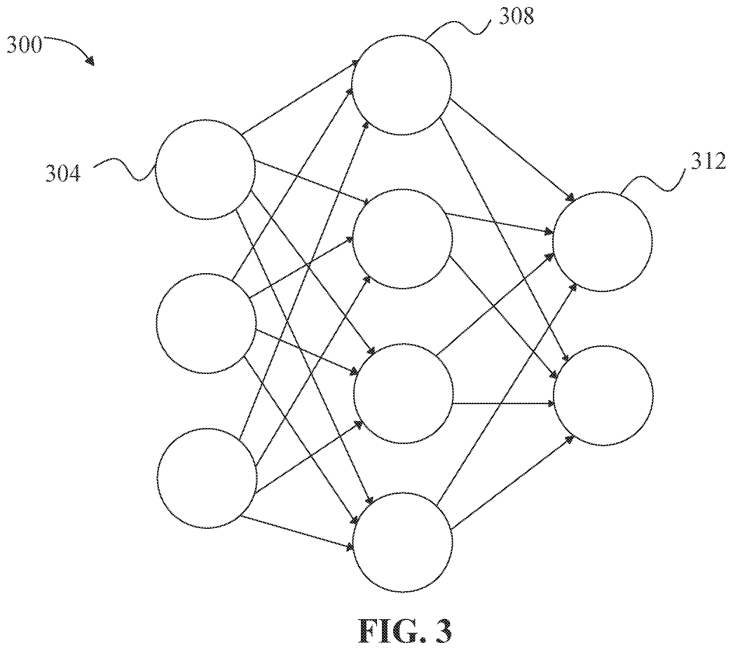

Referring now to FIG. 3, an exemplary embodiment of neural network 300 is illustrated. A neural network 300 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 304, one or more intermediate layers 308, and an output layer of nodes 312. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

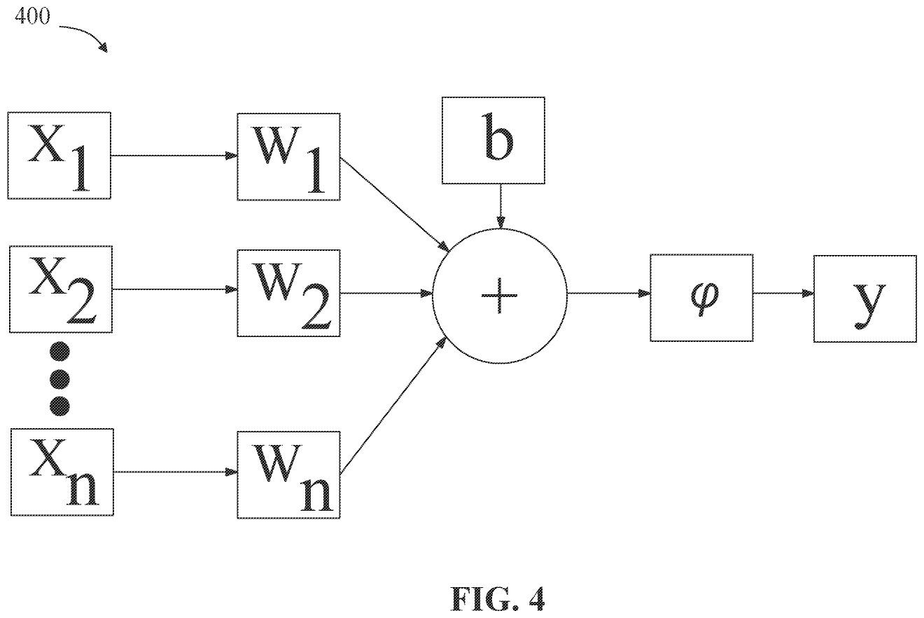

Referring now to FIG. 4, an exemplary embodiment of a node 400 of a neural network is illustrated. A node may include, without limitation, a plurality of inputs x, which may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = = \frac{1}{1 - {e}^{- x}} x$$

given input x, a tanh (hyperbolic tangent) function, of the form

$$\frac{{e}^{x} - {e}^{- x}}{{e}^{x} + {e}^{- x}}$$

a tan h derivative function such as f(x)=tan h²(x), a rectified linear unit function such as f(x)=max (0, x), a “leaky” and/or “parametric” rectified linear unit function such as f(x)=max (ax, x) for some a, an_x for x>0_exponential linear units function such as

$$f ( x ) \{ \begin{matrix}x for x \geq 0 \\ α ( {e}^{x} - 1 ) for x < 0\end{matrix}$$

for some value of a (this function may be replaced and/or weighted by its own derivative in some embodiments), a softmax function such as

$$f ( {x}_{i} ) = \frac{{e}^{x}}{\sum ixi}$$

where the inputs to an instant layer are xᵢ, a swish _{Li}xᵢ function such as f(x)=x*sigmoid(x), a Gaussian error linear unit function such as f(x)=f(x)=a(1+tan h(\sqrt{2/π}(x+bx^{r}))) for some values of a, b, and r, and/or a scaled exponential linear unit function such as

$$f ( x ) = f ( x ) \{ \begin{matrix}α ( {e}^{x} - 1 ) for x < 0 \\ x for x \geq 0\end{matrix} .$$

Fundamentally, there is no limit to the x for x>0_nature of functions of inputs x, that may be used as activation functions. As a non-limiting and illustrative example, node may perform a weighted sum of inputs using weights wi that are multiplied by respective inputs z. Additionally or alternatively, a bias b may be added to the weighted sum of the inputs such that an offset is added to each unit in the neural network layer that is independent of the input to the layer. The weighted sum may then be input into a function co, which may generate one or more outputs y. Weight wi applied to an input x, may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wi may be determined by training a neural network using training data, which may be performed using any suitable process as described above.

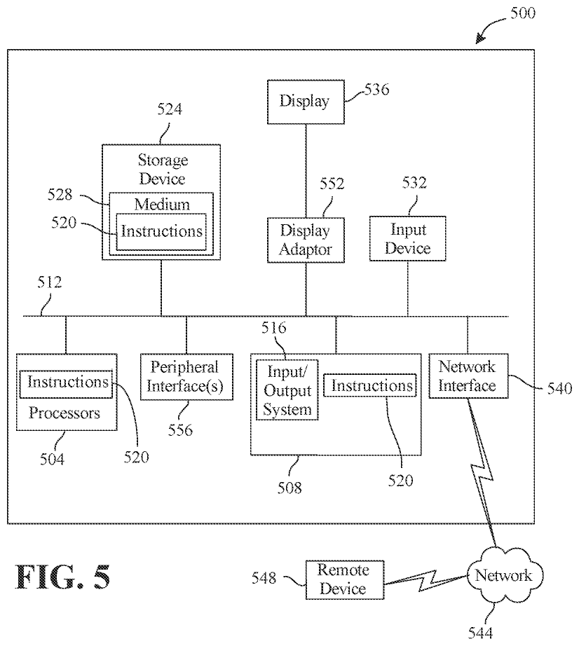

FIG. 5 shows a diagrammatic representation of one embodiment of computing device in the exemplary form of a computer system 500 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 500 includes a processor 504 and a memory 508 that communicate with each other, and with other components, via a bus 512. Bus 512 may include any of several types of bus structures including, but not limited to, a memory bus, a memory controller, a peripheral bus, a local bus, and any combinations thereof, using any of a variety of bus architectures.

Processor 504 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 504 may be organized according to Von Neumann and/or Harvard architecture as a non-limiting example. Processor 504 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC).

Memory 508 may include various components (e.g., machine-readable media) including, but not limited to, a random-access memory component, a read only component, and any combinations thereof. In one example, a basic input/output system 516 (BIOS), including basic routines that help to transfer information between elements within computer system 500, such as during start-up, may be stored in memory 508. Memory 508 may also include (e.g., stored on one or more machine-readable media) instructions (e.g., software) 520 embodying any one or more of the aspects and/or methodologies of the present disclosure. In another example, memory 508 may further include any number of program modules including, but not limited to, an operating system, one or more application programs, other program modules, program data, and any combinations thereof.

Computer system 500 may also include a storage device 524. Examples of a storage device (e.g., storage device 524) include, but are not limited to, a hard disk drive, a magnetic disk drive, an optical disc drive in combination with an optical medium, a solid-state memory device, and any combinations thereof. Storage device 524 may be connected to bus 512 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 524 (or one or more components thereof) may be removably interfaced with computer system 500 (e.g., via an external port connector (not shown)). Particularly, storage device 524 and an associated machine-readable medium 528 may provide nonvolatile and/or volatile storage of machine-readable instructions, data structures, program modules, and/or other data for computer system 500. In one example, software 520 may reside, completely or partially, within machine-readable medium 528. In another example, software 520 may reside, completely or partially, within processor 504.

Computer system 500 may also include an input device 532. In one example, a user of computer system 500 may enter commands and/or other information into computer system 500 via input device 532. Examples of an input device 532 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 532 may be interfaced to bus 512 via any of a variety of interfaces (not shown) including, but not limited to, a serial interface, a parallel interface, a game port, a USB interface, a FIREWIRE interface, a direct interface to bus 512, and any combinations thereof. Input device 532 may include a touch screen interface that may be a part of or separate from display device 536, discussed further below. Input device 532 may be utilized as a user selection device for selecting one or more graphical representations in a graphical interface as described above.

A user may also input commands and/or other information to computer system 500 via storage device 524 (e.g., a removable disk drive, a flash drive, etc.) and/or network interface device 540. A network interface device, such as network interface device 540, may be utilized for connecting computer system 500 to one or more of a variety of networks, such as network 544, and one or more remote devices 548 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 544, may employ a wired and/or a wireless mode of communication. In general, any network topology may be used. Information (e.g., data, software 520, etc.) may be communicated to and/or from computer system 500 via network interface device 540.

Computer system 500 may further include a video display adapter 552 for communicating a displayable image to a display device, such as display device 536. Examples of a display device include, but are not limited to, a liquid crystal display (LCD), a cathode ray tube (CRT), a plasma display, a light emitting diode (LED) display, and any combinations thereof. Display adapter 552 and display device 536 may be utilized in combination with processor 504 to provide graphical representations of aspects of the present disclosure. In addition to a display device, computer system 500 may include one or more other peripheral output devices including, but not limited to, an audio speaker, a printer, and any combinations thereof. Such peripheral output devices may be connected to bus 512 via a peripheral interface 556. Examples of a peripheral interface include, but are not limited to, a serial port, a USB connection, a FIREWIRE connection, a parallel connection, and any combinations thereof.

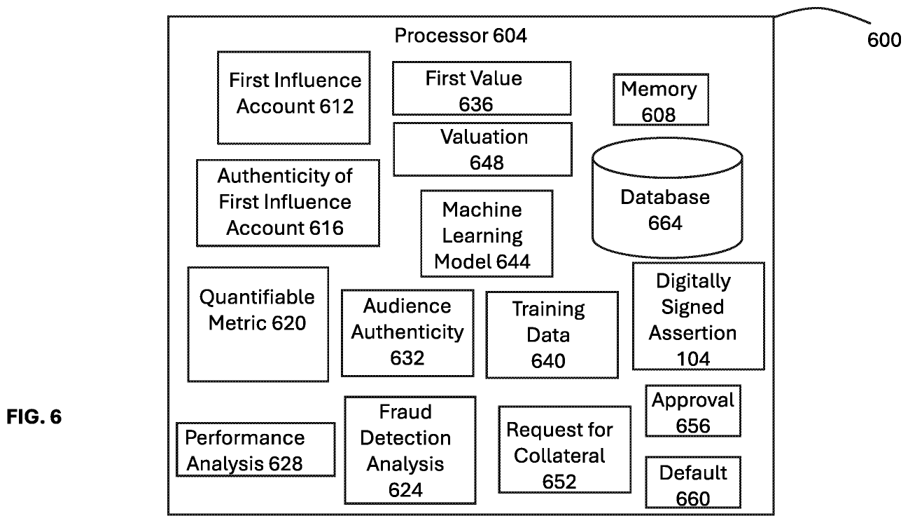

Referring now to FIG. 6, an exemplary embodiment 600 of an apparatus for first influence activation using machine learning is illustrated. Apparatus 600 includes at least a processor 604. Processor 604 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. processor may include a single computing device operating independently, or may include two or more computing device operating in concert, in parallel, sequentially or the like; two or more computing devices may be included together in a single computing device or in two or more computing devices. Processor 604 may interface or communicate with one or more additional devices as described below in further detail via a network interface device. Network interface device may be utilized for connecting processor 604 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. processor 604 may include but is not limited to, for example, a computing device or cluster of computing devices in a first location and a second computing device or cluster of computing devices in a second location. Processor 604 may include one or more computing devices dedicated to data storage, security, distribution of traffic for load balancing, and the like. Processor 604 may distribute one or more computing tasks as described below across a plurality of computing devices of computing device, which may operate in parallel, in series, redundantly, or in any other manner used for distribution of tasks or memory between computing devices. Processor 604 may be implemented using a “shared nothing” architecture in which data is cached at the worker, in an embodiment, this may enable scalability of system 100 and/or computing device. A network configuration may include multihop, mesh, tree, start ring, fully connected, bus, and/or one or more ad hoc networks. Network may include one or more features including but not limited to electromagnetic, sound, radio, and optical. Network may operate in line of sight or long range.

With continued reference to FIG. 6, processor 604 may be designed and/or configured to perform any method, method step, or sequence of method steps in any embodiment described in this disclosure, in any order and with any degree of repetition. For instance, processor 604 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. processor 604 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 6, apparatus 600 includes a memory 608. Memory 608 may include various components (e.g., machine-readable media) including, but not limited to, a random-access memory component, a read only component, and any combinations thereof. In one example, a basic input/output system (BIOS), including basic routines that help to transfer information between elements within apparatus 600, such as during start-up, may be stored in memory. Memory 608 may also include (e.g., stored on one or more machine-readable media) instructions (e.g., software) embodying any one or more of the aspects and/or methodologies of the present disclosure. In another example, memory may further include any number of program modules including, but not limited to, an operating system, one or more application programs, other program modules, program data, and any combinations thereof.

With continued reference to FIG. 6, the at least a processor 604 is configured to receive a first influence account 612 linked to a user. A “first influence account” as used in this disclosure is any social media profile belonging to a person who has the ability to shape opinions, behaviors, or purchasing decisions of their audience through the content that they post. A first influence account 612 may contain a sizeable and engaged audience. The user's first influence account 612 may be built on a platform such as Instagram as produced by Meta Platforms of Menlo Park, California; TikTok as produced by ByteDance of Haidian, Beijing; YouTube as produced by Alphabet, Inc. of Mountain View, California; or X as produced by X Corp. of Bastrop, Texas. Followers of the first influence account 612 may be interested in a specific niche area such as beauty, fitness, gaming, travel, fashion and the like. A user may create posts, videos, and/or stories that resonate with their followers and can guide their actions with recommended products, trends, and/or lifestyle choices. A first influence account 612 may be seen as knowledgeable or relatable in their area of focus. A first influence account 612 may collaborate with brands to promote products or services. A first influence account 612 may post regularly to interact with their audience and build trust and community.

With continued reference to FIG. 6, the at least a processor 604 is configured to confirm the authenticity 616 of the first influence account 612 linked to the user. The “authenticity of the first influence account” as used in this disclosure is any evidence of real human identity, real audience activity, and consistent behavioral patterns. The authenticity 616 of the first influence account 612 may be determined by identifying one or more quantifiable metric 620 linked to the first influence account. A “quantifiable metric” as used in this disclosure, is any indicator that reflect a real person, or organization is the true owner and/or operator of the first influence account. A quantifiable metric 620 may include an identity verification signal, such as a verified badge, matching identity information across platforms, consistent profile details (name, bio, photos, links), official website or email linked, and cross-platform presence that algins with the same identity. A quantifiable metric 620 may include a behavior pattern indicative of a real user. Typically, an authentic account will behave like a human and not a bot by demonstrating natural posting patterns and not 24/7 activity; varied content types (photos, videos, stories, comments), normal language use rather than repetitive or generic text, and real interactions with other users. An account controlled by a bot or a fake spam account may demonstrate mechanical or repetitive behavior.

With continued reference to FIG. 6, a quantifiable metric 620 may include an audience authenticity that reflects followers that have complete profiles, followers who engage meaningfully, no sudden unexplained spikes in follower count, and no large clusters of suspicious or inactive accounts. A quantifiable metric 620 may include engagement quality that reflects how people interact with the account. This may be demonstrated by comments that are specific and relevant, engagement that matches the account's size, and consistent interaction across posts. Cause for concern may be demonstrated by emoji-only comments, repetitive comments from the same accounts, and engagement that is too high or too low for the follower count. A quantifiable metric 620 may include content authenticity as demonstrated by original photos or videos, consistent style or voice, personal stories or behind the scenes content, and real time updates. Cause of concern may be demonstrated by reposted content from other users or the use of stock images. A quantifiable metric 620 may include technical and platform level signals such as IP address consistency, device history, login patterns, age of the account, and any sudden changes in behavior. These may reflect impersonation, automation, or fraud.

With continued reference to FIG. 1, a quantifiable metric 620 may include an engagement rate. An “engagement rate” as used in this disclosure, is a metric that demonstrates how actively people interact with content from a first influence account 612 relative to the size of the audience and/or the number of people who saw a post. Engagement may be measured based on likes or reactions, comments or replies, shares or reposts, saves, link clicks, poll votes or story interactions, and video interactions such as watch time or expands. A quantifiable metric 620 may include a measurement of reach. “Reach” as used in this disclosure, is the number of unique people who saw a piece of content at least once. Reach doesn't measure how many times the content was viewed but rather demonstrates how many individual users it reached. A quantifiable metric 620 may include the number of impressions. “Impressions” as used in this disclosure, are the total number of times a post was displayed on someone's screen. An impression may be counted every time a post appears on a user's screen, including in a feed, on a profile, in explore/discover page, in search results, in recommended content, and as a reshare or repost. A quantifiable metric 620 may include a follower growth. A “follower growth” as used in this disclosure, is the rate at which an account gains or loses followers over time. A follower growth may indicate audience expansion, content performance over time, brand or creator momentum, campaign impact, and audience loyalty. A healthy follower growth may be reflected as steady growth, not full of spikes. Follower growth may be aligned with content output and may be boosted by high performing content. A quantitative metric may include click-throughs. A “click-through” as used in this disclosure, is a measurement of how many times people clicked through a link in a post, story, advertisement, or profile. A click-through may demonstrate how compelling a call to action is, whether content drives traffic to websites, stores, or landing pages, how interested the audience is in learning more, and how effective messaging is at prompting action. A click-through may include a click-through rate which may tell the percentage of viewers who clicked. A quantitative metric may include a conversion. A “conversion” as used in this disclosure, is any action that a user takes to fulfill a specific goal such as moving from interest to action. A conversion may include making a purchase, signing up for a newsletter, filling out a form, downloading an application, registering for an event, starting a new free trial, clicking a link in a bio, sending a direct message, saving a post, sharing content, following an account, and clicking a “Shop Now” or “Learn More” button. A quantitative measurement may include a brand-lift signal. A “brand link signal” as used in this disclosure, is a measurable indicator that reflects whether exposure to social media content has improved how people think, feel, or behave toward a first influence account 612 linked to a user. A brand link signal may include awareness signals, consideration signals, favorability signals, purchase intent signals, and association signals. A brand link signal may be measured by surveys, social listening tools, search trends, behavioral data, and A/B testing.

With continued reference to FIG. 6, a “user” as used in this disclosure is the individual and/or entity that has the legal right to access, control and use the first influence account. A user may have the ability to log in, manage, post, and benefit from the first influence account. A user may have the ability to log into the first influence account, control the audience and followers of a first influence account, monetize the first influence account, and keep the first influence account 612 when a business relationship ends.

With continued reference to FIG. 6, confirming the authenticity 616 of first influence account 616 includes deploying a fraud detection analysis 624 and generating a performance analysis 628 using the fraud detection analysis 624. A “fraud detection analysis” as used in this disclosure, a method, signal, and technology used to identify fake, malicious, and/or deceptive accounts. The fraud detection analysis 624 may include spotting patterns that differ from normal human behavior. This may include analyzing behavioral data, profile attributes, network patterns, and content signals to determine whether an account is genuine or fraudulent. A fraud detection analysis 624 may analyze a first influence account 612 to determine if the account is fake or impersonating someone, if any automated bots are used, if the account has been created for scams, phishing, or misinformation. A fraud detection analysis 624 may determine if an account isp part of a coordinate network, and if the account is using stolen or AI generated identifies. This may aid in ensuring the account maintains adequate integrity, ensures user safety, and creates trust in the brand. The fraud detection analysis 624 may analyze the account's attributes, such as username patterns, missing or stolen profile photos, incomplete or generic biographies, and unusual follower-following ratios. This may be performed using a machine learning process, including any machine learning process as described above in more detail in reference to FIGS. 2-5. In an embodiment, a machine learning process may be deployed to detect fake or low quality profile images and inconsistencies in identity details that may alert the at least a processor 104 to a fake account.

With continued reference to FIG. 6, fraud detection analysis 624 may include an evaluation of behavioral patterns to identify any high posting frequencies, activity at unnatural hours, repetitive or automated comments, mass-following or mass-unfollowing behavior, sudden spikes in activity, and the like. This may also be analyzed using a machine learning process, such as a deep learning model that may analyze these sequential behavioral patterns to detect anomalies. The fraud detection analysis 624 may include a review of content analysis to identify any repetitive or low-quality posts, copied or stolen content, AI-generated images or deepfakes, and any spam links or phishing attempts contained in a first influence account. The at least a processor 104 may utilize natural language processing to help detect suspicious language patterns. Fraud detection analysis 624 may include the detection of network and relationship patterns, such as analyzing clusters of accounts created at the same time, accounts that interact only with a suspicious group, and bot networks that amplify each other's posts. In an embodiment, a graph based model such as a GNN may be used to detect network and relationship patterns. Fraud detection analysis 624 may include device and technical signals such as internal data markers that include IP address anomalies, device fingerprinting, login patterns, and location inconsistencies. These signals may aid in detecting account frauds or automated systems. The fraud detection analysis 624 may utilize one or more machine learning processes to detect for example, transformers that analyze behavior sequences, GANs to detect anomalies and generate training data, autoencoders to identify unusual patterns, and ensemble models to classify accounts as real or fake. In an embodiment, one or more patterns detected from the fraud detection analysis 624 such as profile-level signals, behavioral patterns, content analysis, and network and relationship patterns may be input into a machine leaning model and used to output a fraud detection analysis 624. The fraud detection analysis 624 may be utilized to generate a performance analysis 628. A “performance analysis” as used in this disclosure, is an indication of the effectiveness and performance of the first influence account. A performance analysis 628 may include one or more indicators of visibility, engagement, audience growth, and actions taken by users. It may reflect how well the first influence account's content resonates with its audience and contributes to broader business or brand objectives. A performance analysis 628 may be generated based on one or more industry standards, including but not limited to visibility and awareness, engagement and interaction, audience growth, action and conversion, and brand perception. In an embodiment, a performance analysis 628 may be generated and output as a numerical score, such as with raw numbers, percentages, points, a scaled score, and/or a weighted score. A performance analysis 628 may be generated as a categorical or letter score such as letter grades, proficiency levels, and rating categories. A performance analysis 628 may be generated as rankings, ratios or fractions, star ratings or symbol based scores, percentile scores, composite or index scores, binary scores, visual scores, graphical scores, textual or descriptive scores and the like.

With continued reference to FIG. 6, confirming the authenticity of the first influence account 612, includes analyzing audience authenticity 632. “Audience authenticity” as used in this disclosure, is any indicator of the audience of the first influence account 612 being real, sincere, and meaningfully connected to what is posted. Audience authenticity 632 may include any measurements demonstrating that followers are real humans and are not bots or purchased followers. Audience authenticity 632 may include followers that are genuinely interested in the content and not engaging because of clickbait or artificial incentives. Audience authenticity 632 may include followers that are genuinely aligned with values and messaging rather than following for unrelated reasons. Audience authenticity 632 may include an audience that responds sincerely and is not performing engagement just to be seen. Audience authenticity 632 may reflect trust and credibility of the first influence account. Audience authenticity 632 may enable stronger relationships that are formed from deeper emotional connections and respond to honest, unpolished content. Audience authenticity 632 may enable more long-term engagement as followers care about the content and are more likely to engage consistently than inflated or inauthentic audiences. Audience authenticity 632 may indicate more effective influence which relates to credibility and impact. Audience authenticity 632 may be reflected as comments that reflect real conversation, followers that share personal reactions or stories, engagement that stays steady, and an audience that responds to the first influence account 612 and not just to trends.

With continued reference to FIG. 6, the at least a processor 604 is configured to verify the identity of the user. The user's identity may be verified by verifying login credentials and access controls to the first influence account. This may include verifying a user's ability to login in, control of two factor authentication, access to the recovery email or phone number linked to the first influence account, and verifying the ability to change settings, passwords, or permissions. The user's identity may be verified by supplying information that is linked to the first influence account, such as the email used to create the account, the phone number linked to it, the IP address used to access the account, and/or the date and location of the account creation. The user's identity may be verified by contractors or agreements that specify who owns the account, who owns the content, and what happens if a relationship ends. The user's identity may be verified by business records and employment evidence such as job descriptions, emails assigning account creation or management, company policies, and proof that an account was used for business purposes. The user's identity may be verified by branding and public representation such as use of company names, logos, and trademarks, content focused on business operations, and links to official websites. The user's identity may be verified by content creation and management history such as posting history, who creates or approves content, who responds to messages, and who schedules posts. The user's identity may be verified by platform support verification such as a government identification (ID), proof of access to the linked email or phone, business documents, and any trademark registrations. The user's identity may be verified using financial and monetization records such as payment records, ad revenue deposits, sponsorship contracts, and tax documents.

With continued reference to FIG. 6, the at least a processor 604 calculates a first value 636 for the first influence account 612. A “first value” as used in this disclosure, is an assessment of the intrinsic monetary value of the first influence account. A first value 636 may be calculated by generating a training data 640 set, wherein the training set comprises a plurality of inputs containing influence accounts correlated to outputs containing valuation. “Training data” as used herein, is data containing correlations that a machine learning model 644 and/or machine learning process may use to model relationships between two or more categories of data elements. For instance and without limitation, training data 640 may include a plurality of data entries, also known as “training examples,” each entry representing a set of data elements that were recorded, received, and/or generated together; data elements may be correlated by shared existence in a given data entry, by proximity in a given data entry, or the like. Training data 640 may include any training data 640 suitable for use as training data 640 204 as described above in more detail in reference to FIG. 2. Training data 640 may be sourced from open and public datasets, government data portals, commercial data providers, internal or proprietary data, crowdsourced data, synthetic data, web-scraped or internet scale data, domain specific repositories, and the like. Training data 640 may be sourced from private sources such as but not limited to proprietary organizational data such as internal documents, customer service transcripts, product manuals, industry-specific archives, corporate knowledge bases, and the like. Training data 640 may be sourced from licensed datasets including commercial data providers, industry research firms, and specialized content archives. Training data 640 may be sourced from custom data collected such as custom image or video collection, domain-specific speech recordings, annotated text, and industry regulated data. Training data 640 may be sourced from digitized archives such as legal documents, historical records, audio archives, and government or institutional materials.

With continued reference to FIG. 6, the at least a processor 604 trains a machine learning model 644 using the generated training data 640 set. A “machine learning model” as used in this disclosure, is a process that automatedly uses training data 640 set to generate an algorithm instantiated in hardware or software logic, data structures, and./or functions that will be performed by the at least a processor 604 to produce outputs given data provided as inputs; this is in contrast to a non-machine learning software program where the commands to be executed are determined in advance by a user and written in a programming language. Machine learning model 644 may be implemented as any machine learning process as described above in more detail in reference to FIG. 2.

With continued reference to FIG. 6, the at least a processor is configured to input the first influence account 612 into the trained machine learning model 644 and output a valuation 648 for the first influence account. This may be performed utilizing any methodology as described above in more detail in reference to FIG. 2. A “valuation” as used in this disclosure the process of estimating the worth of the first influence account. With continued reference to FIG. 6, the at least a processor 604 identifies a first value 636 using the valuation 648. Calculating the first value 636 may include determining a future earnings potential. A “future earnings potential” as used in this disclosure, is the expected ability of the first influence account 612 linked to the user to generate income in the future. A future earnings potential includes a forward looking estimate and may be based on factors such as skills, market conditions, growth trends, and historical performance. A future earnings potential may be calculated based on the user's education level, skills and experience, industry salary trends, career trajectory, geographic location, and the like. A future earnings potential may be based on audience size and growth rate, engagement quality and consistency, audience authenticity 632 and trust depth, conversion ability, content velocity, creative adaptability, algorithmic favorability, professionalism, operational maturity, brand safety, reputation stability, platform diversification, owned audience channels, personal brand strength, network strength, long form content capability, monetizable expertise, cultural relevance, trend sensitivity, and the like.

With continued reference to FIG. 6, the at least a processor 604 receives a request for collateral 652 from the user. A “request for collateral” as used in this disclosure, is a request to borrow finances. A request for collateral 652 may include borrowed finance such as a loan, advance, overdraft, and the like. Types of loans may include personal loans, student loans, payday loans, auto loans, mortgage loans, secured loans, unsecured loans, title loans, or any other type of loans a user may want. A request for collateral 652 may also include funding a direct loan to the user or on the user's behalf to pay a debt. A request for collateral 652 may be as simple as the hit of a button or may require more information, such as a credit card application. A request for collateral 652 may seek any information about a user's credentials. The at least a processor 604 may be communicatively connected to a user device and transmit a request for collateral 652 to the at least a processor 604. A request for collateral 652 may be backed by pools of income generating assets such as loans and/or receivables. By pooling the asset backed security with other liquid assets, it offers investors a way to earn returns from the underlying cash flow. Assets such as auto loans, credit card receivables, and mortgage payments may be bundled into a pool. These assets may be transferred to a special purpose vehicle which may issue asset backed securities to investors. The underlying assets such as the loan repayments on the mortgage payments or credit card receivables may generate income which is used to pay interest and principal to asset backed security holders. A request for collateral 652 may include asset backed securities including but not limited to an auto loan asset backed security, a credit card receivable, a student loan asset backed security, a lease based asset backed security, a mortgage backed security, and the like. An asset backed security may be bundled into a pool with one or more other bundled assets, including but not limited to auto loans, credit card receivables, student loan asset based securities, lease based asset backed securities and/or mortgages. The at least a processor 604 may cause user device to prompt user by, as non-limiting examples, audibly reciting the requests over speakers connected to user device and/or visually displaying the requests on a screen of user device. A request for collateral 652 may be a request to borrow finances from a financial institution. In this disclosure, a “financial institution” is an organization licensed to receive deposits from and make loans to users. Examples of financial institutions may be, without limitation, central banks, retail and commercial banks, internet banks, credit unions, savings, loan associations, investment banks, investment companies, brokerage firms, insurance companies, etc. A request for collateral 652 may be communicated through a user device. As used in this disclosure, a “user device” is a computing device controlled and/or operated by a user. Computing device may be any computing device described in this disclosure, such as a processor communicatively connected to a memory. User device may be a personal computer such as a desktop, laptop, smart phone, and/or the like. User device may also include smart television, smart watches, Fitbits, or any other type of device that runs on Android or iOS. A request for collateral 652 may be linked to a specific user, whose identity must be verified to borrow finances. The at least a processor 604 may be configured to require credentials from user device, such as a username and a password, to verify the identity of user. The at least a processor 604 may send verification to user, such as an email to user's email address and/or a text message to user's phone saved on a memory and/or database to which the at least a processor 604 has access. Verification may include a link to click that sends a verification to the at least a processor 604. Verification may include a temporary code for user to then input from user device to confirm that the device is user device.

With continued reference to FIG. 6, as used in this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 6, the at least a processor 604 approves 656 the request for collateral 652 using the first value 636 wherein the first influence account 612 is to be used as an asset for collateral. An “approval” as used in this disclosure is when the user is allowed to borrow finances from the institution. The user must pay back the request for collateral 652. The request for collateral 652 may specify a particular dollar amount that the user seeks to borrow, such as for example, ten thousand dollars, five hundred dollars, one hundred thousand dollars, or any other monetary amount. The at least a processor 604 may approve the request for collateral 652 when the first value 636 meets or exceeds the dollar amount. For example, the at least a processor 604 may approve the request for collateral 652 which specifies a monetary amount of $25,000 when the first value 636 is calculated to be $125,000. In yet another non-limiting example, the at least a processor 604 may deny the approval 656 to the request for collateral 652 which specifies a monetary amount of $5,000 when the first value 636 is calculated to be $250. The approval 656 for the collateral using the first value 636 may contain a restriction whereby the loan or financial assistance is to be used to improve and expand the first influence account 612 linked to the user. This may include requiring the monetary amount to be used for investing in further content creation, brand expansion, and/or account operations such as content strategy, content planning, scripting an ideation, production, publishing, community management, brand voice and tone, visual identity, positioning, storytelling frameworks, audience persona development, performance tracking, audience insights, trend monitoring, SEO & keyword optimization, algorithm strategy, brand outreach and negotiation, rate card creation, contract review, deliverable management, affiliate programs, ad revenue optimization, product development, paid community management, email management, invoicing and payment tracking, accounting & bookkeeping, tax compliance, file organization, project management, legal compliance, contracts and agreements, usage rights for music, images, footage, brand safety practices, crisis management planning, privacy and data handling, trademarking names or logos, community engagement, fan feedback loops, newsletter or SMS list building, hiring and managing contractors, workflow systems, delegations and approval 656, media relations, public appearances, crisis response, brand alignment decisions, long-term image strategy, platform diversification, new product lines, long-term brand partnerships, expansion into new verticals, and/or career planning.

With continued reference to FIG. 6, the at least a processor 604 may identify a default 660 of the asset backed security and block access to the first influence account 612 linked to the user. “Default” as used in this disclosure, is when the user (borrower) fails to meet the terms of the loan agreement and/or the terms of the borrowed finance such as by not making payments on time. Default 660 may be triggered such as when several payments are missed in a row, the full amount is failed to be paid, there is a violation of a loan covenant, adequate amounts of collateral are not maintained, and/or there is a failure to provide financial statements. A default 660 may cause collections activity, damage to credit score, higher interest or penalty fees, acceleration whereby the lender demands the full balance paid immediately, the seizure of collateral (the first influence account 612 and/or legal action. Once the loan is considered to be in default 660, the at least a processor 604 may restrict access of the user to control, log in, manage, and own the first influence account. In such a situation, an application programming interface (API) may connect and control the first influence account 612 until the default 660 payments are caught up. An API may include a set of rules that allows two software systems to communicate with each other. An API may allow for data sharing, features to be used with other systems, an integration of services, and task automation. An API may include for example, REST APIs, SOAP APIs, GraphQL, and/or WebSocket API.

With continued reference to FIG. 6, the at least a processor 604 is configured to store the request for collateral 652 and the approval 656 for the request for collateral 652 on an immutable sequential listing such as by entering a digitally signed assertion 104 as described above in more detail in reference to FIG. 1. This may be performed utilizing any of the methodologies and techniques as described above in more detail in reference to FIG. 1.

With continued reference to FIG. 6, information pertaining to first influence account, quantifiable metric 620, performance analysis 628, first value 636, valuation 648, audience authenticity 632, fraud detection analysis 624, request for collateral 652, training data 640, machine learning model 644 and the like may be stored in database 664. Database 664 may be implemented as a relational database, whereby data is stored in structured tables with strict schemas. Database 664 may be implemented as a non-relational database such as a document database, a key-value database, a column family database, and/or a graph database. Database 664 may be implemented as a hierarchical database which may be structured as a tree like parent-child relationship. Database 664 may be implemented as a network database. Database 664 may be implemented as an object oriented database where data may be stored as objects with attributes and methods. Database 664 may be implemented as a cloud database whereby databases may be hosted and managed in the cloud. Database 664 may be implemented as a vector database to store high dimensional vectors for artificial intelligence and machine learning applications. Database 664 may be organized based on workload, architecture, and/or deployment.

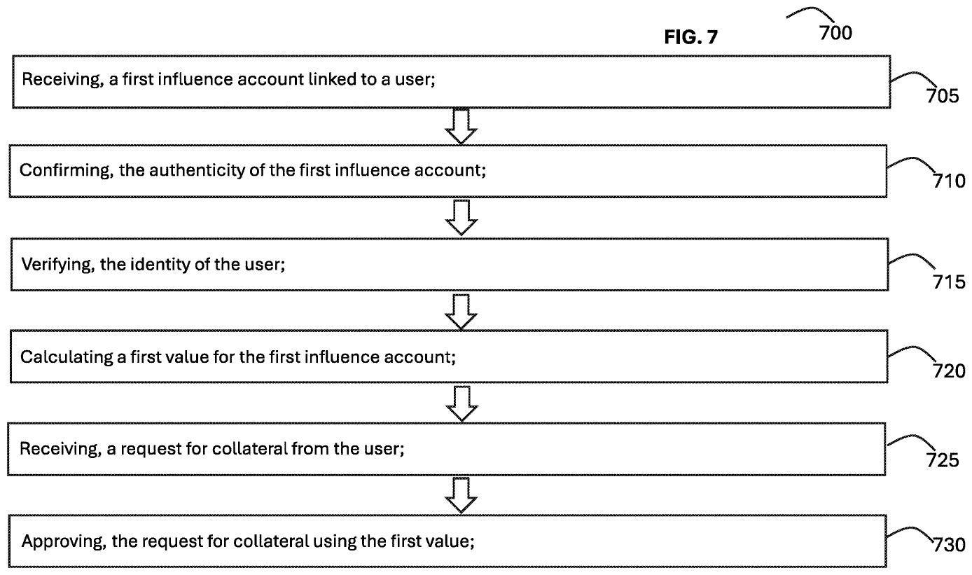

Referring now to FIG. 7, an exemplary embodiment of a method 700 of first influence activation using machine learning is illustrated. At step 705, the at least a processor 604 receives a first influence account 612 linked to a user. The first influence account 612 linked to the user includes any of the first influence accounts linked to a user as described above in more detail in reference to FIG. 6.

With continued reference to FIG. 7, at step 710, the at least a processor 604 confirms the authenticity of the first influence account 612 linked to the user. The authenticity of the first influence account 612 may be determined by utilizing any of the methodologies as described above in more detail in reference to FIG. 6. The authenticity of the first influence account 612 may be determined by deploying a fraud detection analysis 624 and generating a performance analysis 628 using the fraud detection analysis 624. This may be performed utilizing any methodology as described above in more detail in reference to FIG. 6. Confirming the authenticity may include analyzing audience authenticity 632 as described above in more detail in reference to FIG. 6.

With continued reference to FIG. 7, at step 715, the at least a processor 604 verifies the identity of the user. The identity of the user may be verified using any of the methodologies as described above in more detail in reference to FIG. 6. This may include identifying a quantifiable metric 620, including any of the quantifiable metric 620 as described above in more detail in reference to FIG. 6. A quantifiable metric 620 may include for example, engagement rate, reach, impressions, follower growth, click-throughs, conversions, and brand-lift signals.

With continued reference to FIG. 7, at step 720, at least a processor 604 calculates a first value 636 for the first influence account. Calculating the first value 636 includes generating a training data 640 set wherein the training data 640 set comprises a plurality of inputs containing influence accounts correlated to outputs containing valuation 648. The training data 640 set is utilized to train a machine learning model 644 and output a valuation 648 for the first influence account. The valuation 648 is utilized to identify a first value 636. Calculating the first value 636 may include determining a future earnings potential. This may be done utilizing any methodology as described above in more detail in reference to FIG. 6.

With continued reference to FIG. 7, at step 725, the at least a processor 604 receives a request for collateral 652 from the user. The request for collateral 652 includes any request for collateral 652 as described above in more detail in reference to FIG. 6.

With continued reference to FIG. 7, at step 730, the at least a processor 604 approves the request for collateral 652 using the first value 636, wherein the first influence account 612 is to be used as an asset for collateral. The asset backed security may be selected from an investment in content creation, brand expression, and account operations as described above in more detail in reference to FIG. 6. The at least a processor 604 may identify a default 660 of the asset backed security and block access to the first influence account 612 linked to the user. The request for collateral 652 and the approval 656 for the request for collateral 652 may be stored on an immutable sequential listing.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods according to the present disclosure. Accordingly, this description is meant to be taken only by way of example, and not to otherwise limit the scope of this invention.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

### OTHER EMBODIMENTS

The recitation of a listing of elements in any definition of a variable herein includes definitions of that variable as any single element or combination (or sub-combination) of listed elements. The recitation of an embodiment herein includes that embodiment as any single embodiment or in combination with any other embodiments or portions thereof.

The disclosures of each and every patent, patent application, and publication cited herein are hereby incorporated herein by reference in their entirety. While the present disclosure has been disclosed with reference to specific embodiments, it is apparent that other embodiments and variations of the present disclosure may be devised by others skilled in the art without departing from the true spirit and scope of the present disclosure. The appended claims are intended to be construed to include all such embodiments and equivalent variations.

What is claimed is:

1. An apparatus for first influence activation using machine learning, the apparatus comprising:
at least a processor; and
a memory communicatively connected to the at least a processor the memory containing instructions configuring the at least a processor to:
receive a first influence account linked to a user;
confirm the authenticity of the first influence account linked to the user;
verify the identity of the user;
calculate a first value for the first influence account, wherein calculating the first value further comprises:
generating a training data set, wherein the training data set comprises a plurality of inputs containing influence accounts correlated to outputs containing valuations;
training, a machine learning model using the generated training data set;
inputting, the first influence account into the trained machine learning model;
outputting, a valuation for the first influence account; and
identifying a first value using the valuation;
receive a request for collateral from the user; and
approve the request for collateral using the first value, wherein the first influence account is to be used as an asset for collateral.

2. The apparatus of claim 1, wherein calculating the first value further comprises identifying a quantifiable metric linked to the first influence account.

3. The apparatus of claim 2, wherein the quantifiable metric is selected from the group consisting of: engagement rate, reach, impression, follower growth, click-throughs, conversions, and brand-lift signals.

4. The apparatus of claim 1, wherein confirming the authenticity of the first influence account further comprises:
deploying a fraud detection analysis; and
generating a performance analysis using the fraud detection analysis.

5. The apparatus of claim 1, wherein confirming the authenticity of the first influence account further comprises analyzing audience authenticity.

6. The apparatus of claim 1, wherein the request for collateral is bundled in a pool.

7. The apparatus of claim 1, wherein calculating the first value further comprises determining a future earnings potential.

8. The apparatus of claim 1, wherein the asset backed security is selected from the group consisting of: an investment in content creation, brand expression, and account operations.

9. The apparatus of claim 1 further comprising:
identifying a default of the asset backed security; and
blocking access to the first influence account linked to the user.

10. The apparatus of claim 1, wherein the request for collateral and the approval for the request for collateral are stored on an immutable sequential listing.

11. A method of first influence activation using machine learning, the method comprising:
receiving, by at least a processor, a first influence account linked to a user, confirming, by the at least a processor, the authenticity of the first influence account linked to the user;
verifying, by the at least a processor, the identity of the user;
calculating by the at least a processor, a first value for the first influence account, wherein calculating the first value further comprises:
generating a training data set, wherein the training data set comprises a plurality of inputs containing influence accounts correlated to outputs containing valuations;
training, a machine learning model using the generated training data set;
inputting the first influence account into the trained machine learning model;
outputting a valuation for the first influence account; and
identifying a first value using the valuation;
receiving, by the at least a processor, a request for collateral from the user; and
approving, by the at least a processor, the request for collateral using the first value, wherein the first influence account is to be used as an asset for collateral.

12. The method of claim 11, wherein calculating the first value further comprises identifying a quantifiable metric linked to the first influence account.

13. The method of claim 12, wherein the quantifiable metric is selected from the group consisting of: engagement rate, reach, impressions, follower growth, click-throughs, conversions, and brand-lift signals.

14. The method of claim 11, wherein confirming the authenticity of the first influence account further comprises:
deploying a fraud detection analysis; and
generating a performance analysis using the fraud detection analysis.

15. The method of claim 11, wherein confirming the authenticity of the first influence account further comprises analyzing audience authenticity.

16. The method of claim 11, wherein the request for collateral is bundled in a pool.

17. The method of claim 11, wherein calculating the first value further comprises determining a future earnings potential.

18. The method of claim 11, wherein the asset backed security is selected from the group consisting of: an investment in content creation, brand expansion, and account operations.

19. The method of claim 11 further comprising:
identifying a default of the asset backed security; and
blocking access to the first influence account linked to the user.

20. The method of claim 11, wherein the request for collateral and the approval for the request for collateral are stored on an immutable sequential listing.
